(19) United States
(12) Patent Application Publication
(10) Pub. No.: US 2006/0135181 A1
(43) Pub. Date: Jun. 22, 2006

(54) Recipient based scoping of location information

(75) Inventors: Daniel R. Dale, Davie, FL (US); Eric T. Eaton, Lake Worth, FL (US); David J. Hayes, Lake Worth, FL (US); Deepak P. Ahya, Plantation, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/019,887

(22) Filed: Dec. 21, 2004

(51) Int. Cl. H04Q 7/20

(52) U.S. Cl. 455/456.5; 455/456.6

(57) ABSTRACT

A method (50) and system (10) for recipient based scoping of location information can include a communication device (12, 14, or 16) within a communication network and a processor (22, 28, or 32) coupled to the communication network. The processor can be programmed to obtain or receive (52) location information having more than one level of granularity and automatically adjusting (54) a level of granularity of the location information at the communication device based on location related characteristics of a recipient (39) at a selective call receiver (14).

### FIELD OF THE INVENTION

This invention relates generally to communication systems, and more particularly to a method and system for scoping data based on information related to a recipient.

### BACKGROUND OF THE INVENTION

A current demand exists for a phone equipped with the capability of quickly and easily (e.g. through a single button press) sending status messages out to other people. A portion of these status messages will include location specific information to let the recipient of the message know both the status of the sender and their current location. For instance, a message might read “Johnny is OK in Sawgrass Mills Mall.” Although this information might be useful to someone with location knowledge of where in the world Sawgrass Mills Mall is located, a person unfamiliar with Sawgrass Mills Mall might wonder where this location exists. In other words, the scope of the location information creates a problem for a recipient unfamiliar with a predetermined area that is likely local to the sender. Unless a recipient knows the specific area and location of Sawgrass Mills Mall, then this location information will have little or no meaning to him or her. Also, notwithstanding the issues with familiarity, the further away the recipient is from the sender, the less likely it is that the recipient cares about specifics of a sender's location information. Conversely, when the recipient knows the specific area and location of Sawgrass Mills Mall, it is more informative to use this more specific location description.

No known existing device or system automatically chooses a location description that is compatible with either a priori knowledge of the recipient's familiarity of the location or a priori knowledge of the recipient's desire for detailed information or both. Some CD or DVD-based vehicle navigation systems, such as the RoadMate 500 by Magellan provide turn-by-turn guidance with voice prompting turn-by-turn. The voice prompt tells the driver when to turn. The RoadMate 500 further include an advanced points of interest (POI) database. The POI database provides comprehensive listings in your downloaded region, including businesses, banks, hotels, airports, gas stations, ATMs, and restaurants. In this regard, the RoadMate also provides a feature called “Map View” that enables zooming in or out on a detail map, although not automatically or dynamically based on a recipient's location related information. Another vehicle navigation system by Panasonic (Part Number: DV2300VM5805) enables a user to enter a post code to quickly narrow down their choice and further provides automatic intersection zoom display, Although the automatic intersection zoom feature might be based on knowledge of location information from a GPS satellite, this “automatic” zooming feature is not based on a priori knowledge of a user's selective call address or other location information that might be stored in the device. The intersection zooming is not done dynamically based on the user's familiarity with a particular location, but rather done statically based on the vehicle's present location based on knowledge of GPS coordinates. None of the devices described above utilize a user's familiarity with a particular location as determined by a selective call address or other location related information available (at a communication device or remote device in communication with the communication device) extracted from a user's use of the communication device or system. Further note, a GPS device is not an addressed device or communication device having a selective call address such as a pager or cellular phone. Even though many vehicles offer both built-in navigation systems and cellular phone systems, none have utilized location related information from a cell phone to further enhance mapping features on the navigation system.

### SUMMARY OF THE INVENTION

Embodiments in accordance with the present invention can provide a means for scoping location information to a level that will likely be more informative and significant to a recipient based on information related to the recipient. As a quick example, a recipient in California will unlikely know specific local information in Florida being sent by a sender in Florida, but will probably find more informative and useful information that is less specific. For someone in California, a status message reading “Johnny is OK in the Fort Lauderdale, Fla. area” would be more effective than a messaging reading “Johnny is OK in Sawgrass Mills Mall”. Although the scope of location information might be available to the recipient at various levels, embodiments in accordance with the invention can use the relative distance between sender and recipient to determine the scope level of information the recipient will initially see. Note, in some circumstances, the recipient in California will be familiar with the Florida location. For example, if the recipient is a Florida resident traveling in California. Alternate embodiments can compensate for this by using other recipient information such as the area code of the recipient's phone number to determine the scope of the location description.

In a first embodiment of the present invention, a method of recipient based scoping of location information can include the step of dynamic scoping of information related to a location based on at least one recipient characteristic and its relationship to the location. The step of dynamic scoping can includes the step of automatic selection of or choosing of a location description to be included in the information related to the location. Note, the step of dynamic scoping can include scoping the information related to the location at one among a sending device, a receiving device and an intermediary device. Also note, the recipient characteristic can be a selective call address of the recipient or any among a current location of a recipient, a previous location of the recipient, contact information of the recipient, user information which includes personalized landmarks stored by a user, historical zoom information of the user, a manual selection by a sender, or a manual selection by a recipient. Scoping can also include scoping by a receiving device by performing at least one among: a) receiving an absolute location and choosing a description using resources at the receiving device, b) receiving an absolute location and choosing a description using a sender's best guess, and c) receiving a list of descriptions and choosing a description among the list.

In a second embodiment of the present invention, a method of recipient based scoping of location information can include the steps of automatically scoping the location information or adjusting a level of granularity of the location information based on at least one location related characteristic of the recipient at a selective call receiver and receiving location information at the selective call receiver. Note, the location information can have more than one level of granularity. Adjusting the level of granularity can include adjusting the level of granularity based on at least one among a destination address of a message containing the location information, a current location of the selective call receiver, a previous location of the selective call receiver, and on a user defined instruction. The step of adjusting can further include the step of adjusting the level of granularity of the location information based on a user information extracted from use of the selective call receiver. The step of adjusting can also include the step of providing more granularity when the selective call receiver is determined to be closer to a sender of a message containing the location information and the step of providing less granularity when the selective call receiver is determined to be further away from the sender of the message containing the location information. The method can further include the step of displaying the location information with the automatically adjusted level of granularity.

In a third embodiment of the present invention, a system for recipient based scoping of location information can include a communication device within a communication network and a processor coupled to the communication network. The processor can be programmed to obtain location information having more than one level of granularity and automatically adjusting a level of granularity of the location information at the communication device based on location related characteristics of a recipient at a selective call receiver. The communication device can be a transmitting device having the location information and knowing information about the recipient or alternatively the communication device can be the selective call receiver of the recipient. The processor can be further programmed to enable the recipient to choose a scope of the location information or to enable the selective call receiver to choose a scope of the location information based on information the selective call receiver has about itself. In another alternative, the communication device can be a server on the communication network that automatically adjusts the level of granularity of the location information at the server to be sent to the selective call receiver based on information known about the recipient at the selective call receiver. Further note that the processor can automatically adjust by adjusting the level of granularity of the location information based on any among a destination address of a message containing the location information, a current location of the selective call receiver, a typical location of the selective call receiver, and on a user defined instruction. The processor can also automatically adjust by adjusting the level of granularity of the location information based on a user information extracted from use of the selective call receiver. The processor can also automatically adjust by providing more granularity when the selective call receiver is determined to be closer to a sender of a message containing the location information and providing less granularity when the selective call receiver is determined to be further away from the sender of the message containing the location information. The processor can further be programmed to display the location information with the automatically adjusted level of granularity at the selective call receiver.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a communication system in accordance with the present invention.

FIG. 2 is a flow chart illustrating a method of recipient based scoping of location information in accordance with an embodiment of the present invention.

FIG. 3 is flow chart illustrating a method of recipient based scoping of location information in accordance with another embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

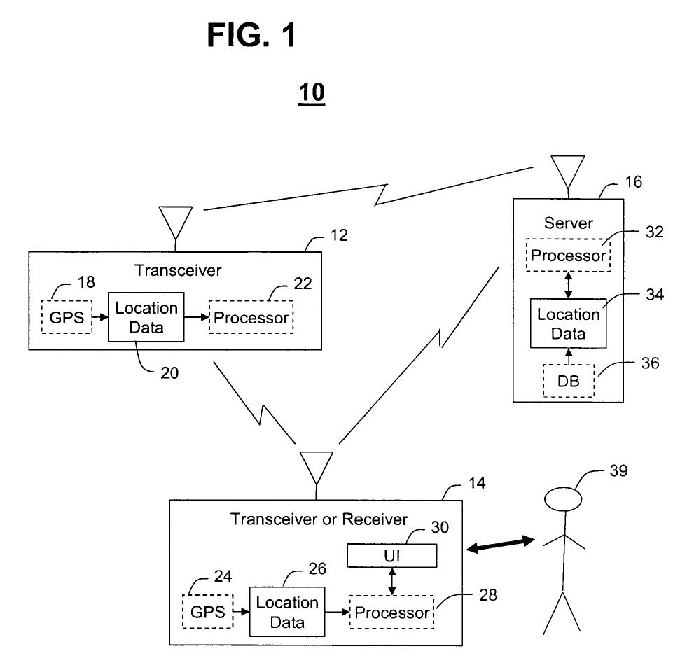

Referring to FIG. 1, a block diagram of a system 10 in accordance with an embodiment of the present invention for recipient based scoping of location information is illustrated. The system 10 can include a communication device within a communication network and a processor coupled to the communication network. The communication device can be a transceiver 12 that sends location information to a recipient 39, a receiver or transceiver 14 that receives location information from the transceiver 12 or a server 16, or the communication device can be the server 16 itself. All three devices or any two among the communication devices 12, 14 and 16 can form the communication network. The server can either relay location information from the transceiver 12 to the device 14 or originate location information itself and send it to the device 14. The system 10 further includes a processor that can be programmed to obtain location information having more than one level of granularity and that automatically or dynamically scopes or adjusts a level of granularity of the location information at the communication device based on at least one location related characteristic of a recipient at a selective call receiver. Note, the processor 22, 28 or 32 performing the scoping function described above can reside at any among the devices 12, 14, or 16 respectively. In other words, the scoping can be performed at any among a sending device, a receiving device, or an intermediate device such as a server. The communication device can be a transmitting device such as transceiver 12 having the location information and knowing information about the recipient or alternatively the communication device can be the selective call receiver or transceiver 14 of the recipient 39.

In the case of the transceiver or sending or transmitting device 12, location data 20 can include location data about the recipient 39 and/or device 14 in various forms including a destination address such as an area code or other information indicative of the location or the desired granularity of location information wanted by the recipient 39. The location information 20 at device 12 could also include specific coordinates determined by a GPS receiver 24 or other location determining circuitry at the device 14 which has been received at device 12 (either directly from device 14 or via server 16). The location information 20 can also include GPS information from a GPS receiver 18 at device 12 that can be used to determine the relative distances between device 12 and device 14 to assist in making scoping adjustments as will become further apparent.

The location data 26 at the receiver or transceiver 14 can also include location data about the recipient 39 and/or device 14 in various forms including its own address such as an area code or other information indicative of the location or the desired granularity of location information wanted by the recipient 39. In this regard, the processor 28 can enable the recipient to choose a scope of the location information or to enable the selective call receiver (14) to choose a scope of the location information based on information the selective call receiver has about itself. As examples, the location information 26 can be automatically obtained from data such as identification codes that might be received from a base station server (16) or cell site in a cellular system or GPS information from a local GPS receiver 24 or the location information 26 can be user specified by the recipient (39) user. In a more specific example, the recipient can create or the device 14 can automatically create a list of cities or other specific areas (possibly based on time spent in a particular area or based on other criteria) that the recipient is familiar with. In that instance, the processor 28 can use this location list to determine the level of granularity the recipient might want to see regardless of distance between a sender (12) and the recipient 39. The location information 26 can also be information that is gathered from tracking the habits and inputs from the recipient 39. In another example, the processor can scan addresses in a recipient's electronic address book or other location related data in the data store of the device 14 to make a decision as to the level of granularity the recipient might want to see. If a user or the recipient 39 is entering or viewing user (or other) information, the recipient can utilize a user interface 30 that can include a display, light indicators, speakers, speech synthesis engines, and user input entry devices including, but not limited to keypads, buttons, microphones, speech recognition engines and the like.

Location data 34 at the server 16 can likewise include location data about the recipient 39 and/or device 14 in various forms as previously discussed with regard to devices 12 and 14. Additionally, the server can also maintain a database 36 of location information with respect to the recipient device 14 or the sending device 12 or both. The location data 34 can be utilized by the processor 32 to make location scoping decisions when sending location information to the recipient device 14. The processor 32 (or processor 28 or processor 22) can automatically adjust the level of granularity of the location information based on any among a destination address of a message containing the location information, a current location of the selective call receiver, a typical location of the selective call receiver, and on a user defined instruction. The processor(s) 32, 28 or 22 can also automatically adjust the level of granularity of the location information based on a user information extracted from use of the selective call receiver by the recipient. The processor(s) can also automatically adjust by providing more granularity when the selective call receiver is determined to be closer to a sender of a message containing the location information and providing less granularity when the selective call receiver is determined to be further away from the sender of the message containing the location information. The processor(s) can further be programmed to display the location information with the automatically adjusted level of granularity at the selective call receiver or recipient device 14. With respect to user defined options, in one embodiment the recipient 39 can decide what scope the receiver wishes to see. While the entire hierarchy of the specific location can be sent to the recipient's device 14, the recipient's device based on user preferences, its location, or other location related data can decide which part of the hierarchy (scope) to display. Whether the scoping results from user preferences or automatically using other location data or a combination of both, another optional feature can enable the recipient to zoom in and out to get finer or coarser resolution or granularity without further querying sender.

When sending location information in a status message using a consumer homeland security phone for example, information about the recipient of the message can be taken into account and the scope of the sender's location information can be adjusted accordingly. The information about the recipient can be something indicating how likely it is that the recipient is familiar with the area in which the sender is located. This information can be based on for example a destination address of the message, a current location of the recipient, a typical location of the recipient, a typical range of the recipient, or a user defined or learned familiarity information (the user can enter areas he or she is familiar with, or the program may learn such information from previous actions of the user).

For the location based methods, the further away a recipient, the less specific the location information sent to him or her. The scope of the location information contained in the status message dynamically changes depending on how far away the recipient is from the location of the sender. Area code and current location of the recipient can also be used to drive the scoping. If a recipient's area code matches the location of the sender, a specific message can be displayed since it would be safe to assume the recipient has knowledge of the area. If this algorithm fails to find a match, a “Where's That” button (to the user interface 30 for example) can be added that contextually zooms out to broader detail or to a level having less granularity.

In a more specific example, if a traveler goes to Chicago alone and sends his wife in Fort Lauderdale an “I'm OK” message, it is likely that “I'm OK in the Chicago Area” is acceptable. Alternatively, if a teen is traveling with their parents to Chicago, the parents will likely want more specific information like “I'm OK at the Gurnee Mill Mall”. With this implementation, recipients who have no concept of (or no interest in) the sender's specific local area can be presented with the most meaningful message to them in a dynamic fashion based on location information. It makes the messages more useful, and therefore creates a greater sense of security and peace of mind.

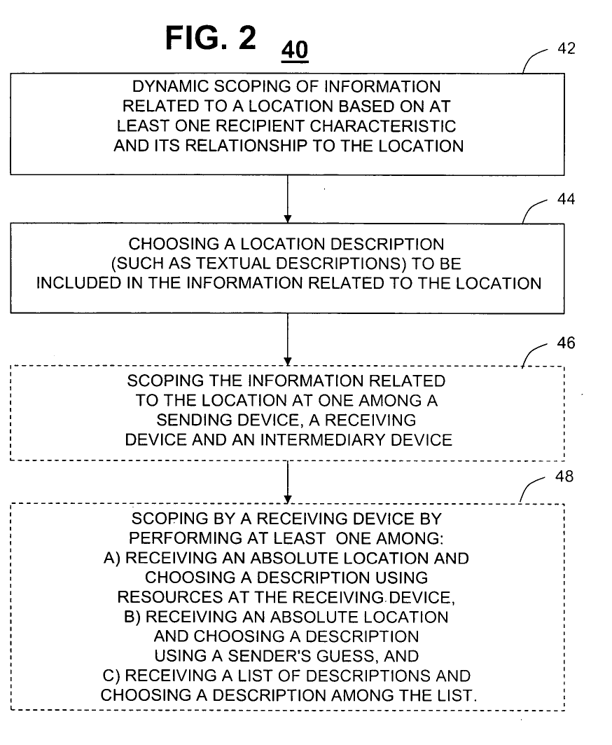

Referring to FIG. 2, a flow chart illustrating a method 40 of recipient based scoping of location information is shown. The method 40 can include the step 42 of dynamic scoping of information related to a location based on at least one recipient characteristic and its relationship to the location. The step of dynamic scoping can include the step 44 of choosing a location description (such as textual description) contained in the information related to the location. Note, the step of dynamic scoping can include the step 46 of scoping the information related to the location at one among a sending device, a receiving device and an intermediary device. For example, the sending device can be a cell phone, the receiving device can be a personal computer, and the intermediary device can be a messaging server. In this example, the cell phone can scope the information related to the location before sending it, the personal computer can scope the information related to the location after receiving it and before presenting it to the user, or the messaging server can scope the information related to the location after receiving it and before forwarding it to the personal computer. Also note, the recipient characteristic can be any among a current location of a recipient, a previous location of the recipient, a selective call address of the recipient (for example the area code of the phone number), contact information of the recipient (for example the home address of the recipient), user information which includes personalized landmarks stored by a user or stored on the user's device, historical zoom information of the user (for example how the user manually scoped location information in a nearby location), a manual selection by a sender, and a manual selection by a recipient. Scoping at step 48 can also include scoping by a receiving device by performing at least one among: a) receiving an absolute location and choosing a description using resources at the receiving device, b) receiving an absolute location and choosing a description using a senders best guess, and c) receiving a list of descriptions and choosing a description among the list. Scoping can also be performed by the sending device (not shown) by choosing a location description that includes the name of a nearby smaller city when the recipient is likely to be familiar with the area or likely to want detailed information or choosing a location description that includes the name of a nearby larger city when the recipient is likely not familiar with the area or likely not wanting detailed information. Additionally, the sending device may include in the location related information a map or an aerial image or a hyperlink to a map or an aerial image where the zoom level of the map or the aerial image is chosen by the sending device based on the likelihood of the recipient being familiar with the area or wanting more detail.

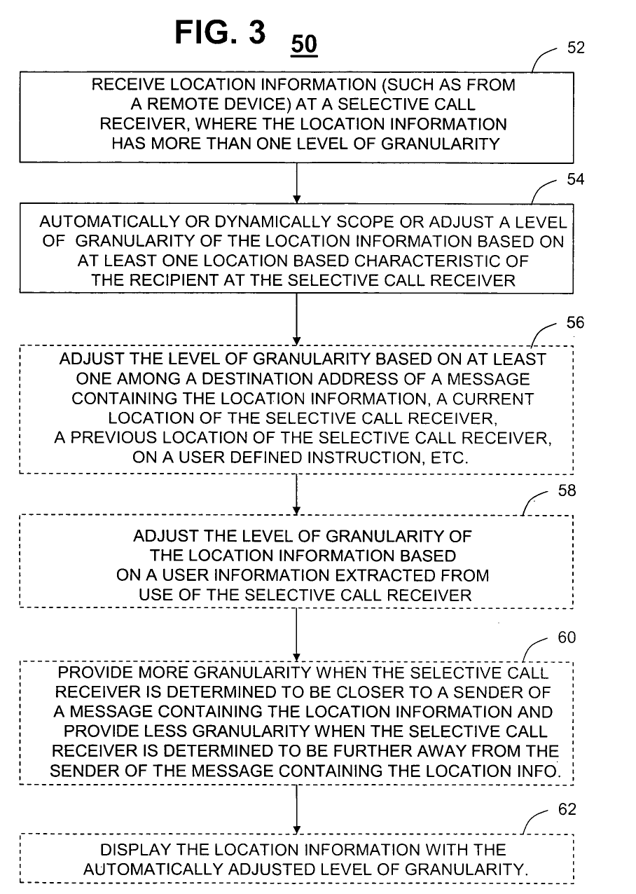

Referring to FIG. 3, another flow chart illustrating a method 50 of recipient based scoping of location information is shown. The method 50 can include the step 52 of receiving location information (such as from a remote device) at a selective call receiver and the step 54 of automatically or dynamically scoping or adjusting a level of granularity of the location information based on location related characteristics of the recipient at the selective call receiver. Note, the order of the steps above are not essential in that scoping or adjusting the location information can be done before or after receiving the location information at the selective call receiver since the scoping function can be performed (as previously noted) at a sending device, a receiving device or an intermediary device (such as server). Further note, the location information can have more than one level of granularity. Adjusting the level of granularity can include adjusting the level of granularity at step 56 based on at least one among a destination address of a message containing the location information (e.g., an area code), a current location of the selective call receiver, a previous location of the selective call receiver, contact information stored at the selective call receiver (e.g., if a high percentage of contacts are located in a particular location, the user is deemed to be familiar with the particular location), user information which can include personalized landmarks stored by the user, historical zoom information (e.g., how the user viewed nearby locations in the past), and on a user defined or manual instruction (by either the sender or the recipient). The step of adjusting can further include the step 58 of adjusting the level of granularity of the location information based on a user information extracted from use of the selective call receiver. The step of adjusting can also include providing more granularity when the selective call receiver is determined to be closer to a sender of a message containing the location information and providing less granularity when the selective call receiver is determined to be further away from the sender of the message containing the location information at step 60. Scoping can also be achieved by simply choosing a location description contained in the location information received. Further note that scoping by the selective call receiver can be done in other instances as well. For example, the selective call receiver can choose a description using its own resources (such as personal landmarks stored by a user) when the recipient only receives an absolute location (e.g., a latitude and longitude). In another example, scoping can be done similarly when the recipient receives an absolute location and a description in the form of a sender's best guess. In yet another alternative, the recipient gets a list of descriptions and accordingly scopes the location information using techniques described above. The method 50 can further include the step 62 of displaying the location information with the automatically adjusted level of granularity.

As noted above, the method 50 can be implemented in a number of devices that can provide dynamic scoping of location information. In a sending or transmitting device (12), if the device 12 knows the information about the recipient and/or their device 14, then the sending device 12 can tailor the scope of the sent message based on the knowledge known about the recipient. In a recipient's device 14, such device can choose a scope of the received location information that it presents to the user based on the information it has about itself. In an intermediate device (16) such as a messaging server), the location information in the message can be transformed by the intermediate device 16 based on information it has about the recipient.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. For example, while text location information is the primary focus as illustrated in the embodiment herein, other embodiments need not be limited to text messages and can include location information in the form of graphics such as a map image where the zoom level of the map image can be adjusted based on the recipient's location related information. Additionally, the description above is intended by way of example only and is not intended to limit the present invention in any way, except as set forth in the following claims.

What is claimed is:

1. A method of recipient based scoping of location information, comprising the step of:
dynamic scoping of information related to a location based on at least one recipient characteristic and its relationship to the location, wherein dynamic scoping includes the step of choosing a location description to be included in the information related to the location.

2. The method of claim 1, wherein the information related to the location is exchanged between two devices.

3. The method of claim 1, wherein the step of dynamic scoping comprises scoping the information related to the location occurs at one among a sending device, a receiving device and an intermediary device.

4. The method of claim 1, wherein the at least one recipient characteristic is selected among a selective call address of a recipient device and contact information of the recipient stored a priori.

5. The method of claim 1, wherein the at least one recipient characteristic is selected among user information which includes landmarks stored by the recipient, historical zoom information of the user, a current location of a recipient, a previous location of the recipient, a manual selection by a sender, and a manual selection by a recipient.

6. The method of claim 1, wherein the step of scoping comprises scoping by a receiving device by performing at least one among: a) receiving an absolute location and choosing a description using resources at the receiving device, b) receiving an absolute location and a sender's best guess at a description and choosing either the sender's guess or an alternate description, and c) receiving a list of descriptions and choosing a description among the list.

7. A method of recipient based scoping of location information, comprising the steps of:
automatically scoping the location information based on at least one location related characteristic of a recipient at a selective call receiver; and
receiving the location information at the selective call receiver.

8. The method of claim 7, wherein the step of automatically scoping comprises the step of choosing a location description to be included in the location information.

9. The method of claim 7, wherein the step of automatically scoping can occur at any among the remote device, the selective call receiver, or an intermediate device.

10. The method of claim 7, wherein the step of automatically scoping comprises the step of adjusting a level of granularity of the location information based on at least one among a destination address of a message containing the location information, a current location of the selective call receiver, a previous location of the selective call receiver, and a user defined instruction.

11. The method of claim 7, wherein the step of automatically adjusting comprises the step of adjusting the level of granularity of the location information based on any location related characteristic of the recipient among a destination address of a message containing the location information, a current location of the selective call receiver, a previous location of the selective call receiver, contact information in a contact list having location information, user information having personalized landmarks stored in the selective call receiver, historical zoom information, and on a user defined instruction.

12. The method of claim 7, wherein the method further comprises the step of displaying the location information with an automatically adjusted level of granularity.

13. The method of claim 7, wherein the step of automatically adjusting comprises the step of providing more granularity when the selective call receiver is determined to be closer to a sender of a message containing the location information and the step of providing less granularity when the selective call receiver is determined to be further away from the sender of the message containing the location information.

14. The method of claim 13, wherein the step of automatically adjusting based on user defined instructions comprises the step of receiving an entire hierarchy of location information at the selective call receiver and receiving a selective input from a user determining which part of the hierarchy to display to provide finer or coarser resolution or granularity.

15. The method of claim 7, wherein the step of receiving location information comprises receiving at least one among an absolute location, a sender's guess as to the recipient's desired scoping level, and a list of location descriptions.

16. A system for recipient based scoping of location information, comprising:
a communication device within a communication network; and
a processor coupled to the communication network, wherein the processor is programmed to:
obtain location information having more than one level of granularity; and
automatically adjusting a level of granularity of the location information at the communication device based on at least one location related characteristic of a recipient at a selective call receiver.

17. The system of claim 16, wherein the communication device is one among a transmitting device having the location information and knowing information about the recipient and the selective call receiver of the recipient.

18. The system of claim 16, wherein the processor is further programmed to enable the selective call receiver to choose a scope of the location information based on information the selective call receiver has about itself.

19. The system of claim 16, wherein the communication device is a server on the communication network that automatically adjusts the level of granularity of the location information at the server to be sent to the selective call receiver based on information known about the recipient at the selective call receiver.

20. The system of claim 16, wherein the processor automatically adjusts by adjusting the level of granularity of the location information based on any location related characteristic of the recipient among a destination address of a message containing the location information, a current location of the selective call receiver, a previous location of the selective call receiver, contact information in a contact list having location information, user information having personalized landmarks stored in the selective call receiver, historical zoom information, and on a user defined instruction.
